(19) United States
(12) Patent Application Publication
(10) Pub. No.: US 2008/0169369 A1
(43) Pub. Date: Jul. 17, 2008

(54) Movable covering board for shredder opening

(75) Inventor: T.C. Wang, SanChung City (TW)

Correspondence Address: BACON & THOMAS, PLLC, 625 SLATERS LANE, FOURTH FLOOR, ALEXANDRIA, VA, 22314, US

(73) Assignee: Michilin Prosperity Co., Ltd., SanChung City (TW)

(21) Appl. No.: 11/878,484

(22) Filed: Jul. 25, 2007

(30) Foreign Application Priority Data
Jan. 11, 2007 (CN) 200720001237.7

(51) Int. Cl. B02C 23/04

(52) U.S. Cl. 241/37.5

(57) ABSTRACT

This specification discloses a movable covering board for the shredder opening. A movable covering board is disposed by the shredder opening. By changing the relative position of the covering board and the opening, it is possible to change the width of the shredder opening to its largest possible default width when paper jams happen. A switch is provided in the moving stroke of the movable covering board in order to shut down the power of the shredder at the same time of moving the movable covering board for the safety of the user.

### BACKGROUND OF THE INVENTION

1. Field of Invention

The invention relates to a shredder and, in particular, to a shredder with a movable covering board for its opening. When paper jams occur to the shredder, the width of the opening is changed to a larger default width for the user to take out the jammed paper. At the same time, the power of the shredder is shut down for the safety of the user.

2. Related Art

To prevent such documents as legal files, receipts, invoices, credit card numbers, research reports, or personal financial information (e.g., credit card and phone bills) from being released, it is common to destroy them using a shredder. Therefore, the shredder has become an indispensable device for both business and home applications.

The US Consumer Product Safety Commission (CPSC) issued document No. 5127 in response to paper shredder safety alert. The document reminded families with shredders to be cautious about the safety in operating the shredders. It pointed out that 31 cases of finger injuries from operating shredders have been the received reports between January 2000 and December 2003, and most of the people who got hurt were children aged from 14 months to 2 years, particularly the toddlers. This is because children at these ages like to mimic adults and play shredder without the adult's supervision. It is not guaranteed that no accident will happen even under the adult's supervision. This is because the pulling force exert by the shredder on the paper is very large. If the fingers holding the paper do not let go, the pulling force may also pull the fingers into the shredder opening and cause injuries.

Therefore, the CPSC cautioned consumers about the following things:
1. Do not let children to operate shredders by themselves. Even under supervision, the adult should know that there is a risk that the pulling force of the shredder may be strong enough to pull children's fingers into the shredder opening.
2. Keep shredders away from children.
3. Unplug the shredder when not in use.
4. Do not put hands or fingers on the shredder.
5. Do not operate shredders when wearing clothes with loose ends or strips to avoid being pulled into the shredder opening.
6. Keep an appropriate distance between the tie or zipper and the shredder opening.

The opening width of an ordinary shredder is about 6 mm. This is wide enough for a child to stick in fingers and get hurt by the blades. Some people may think simply reducing the width of the opening can prevent user's fingers from being pulled into the opening and getting hurt. However, the width of the shredder opening has to satisfy the needs for both auto and rev functions. Therefore, a narrow opening would be a problem for removing the jammed paper. Therefore, it is an important to provide a shredder convenient for removing the jammed paper if jams happen.

### SUMMARY OF THE INVENTION

In view of the foregoing, an objective of the invention is to provide a shredder that has its opening kept at the smallest default width when it is running is the normal auto mode to prevent injuries to user's fingers and kept at the largest default width when it is running in the rev mode for the convenience of the user to take out jammed paper.

Another objective of the invention is to provide a shredder that shuts down its power when it is changed to the rev mode by the user. The motor thus stops to ensure the user's safety.

To achieve the above objectives, a movable covering board is provided by the shredder opening. By changing the relative position between the covering board and the opening, the width of the opening becomes the largest default width when paper jams happen and the shredder is running in the rev mode for the user to remove the jammed paper. A switch is further provided in the moving stroke of the moving board so that the power of the shredder is shut down while moving the covering board for the safety of the user.

### BRIEF DESCRIPTION OF THE DRAWINGS

The invention will become more fully understood from the detailed description given herein below illustration only, and thus is not limitative of the present invention, and wherein:

FIG. 1 is an exploded view of the structure of the invention;

FIG. 2 is an exploded view of the structure from another viewing angle;

FIG. 3 is a locally enlarged view of part A in FIG. 2;

FIG. 4 is a locally enlarged view of part B in FIG. 2; and

FIG. 5 is a schematic view showing how the movable covering board functions according to the invention.

### DETAILED DESCRIPTION OF THE INVENTION

The present invention will be apparent from the following detailed description, which proceeds with reference to the accompanying drawings, wherein the same references relate to the same elements.

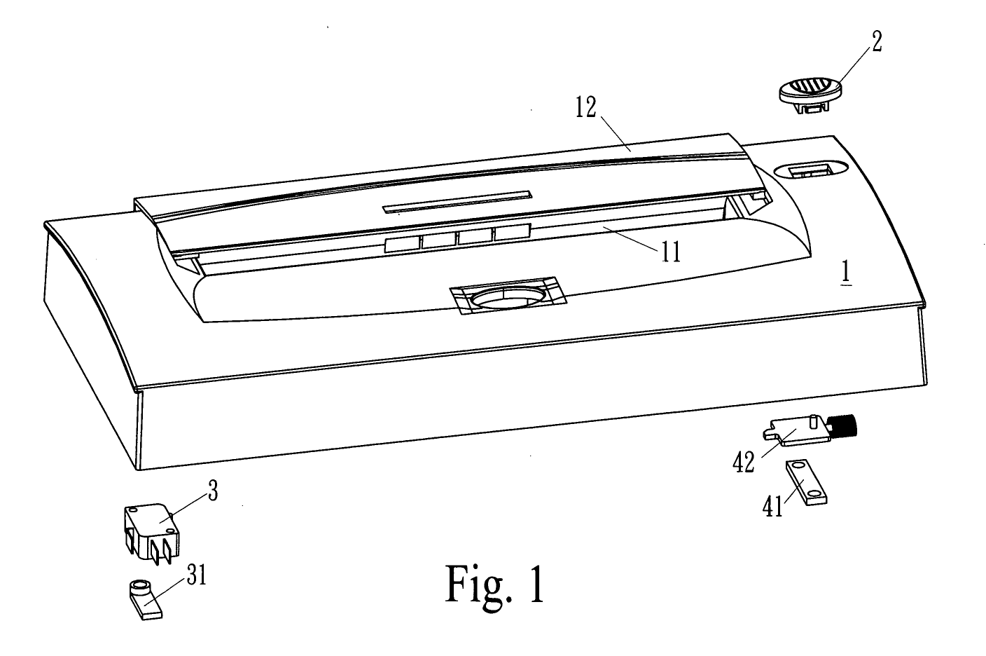

With reference to FIG. 1, the opening 11 in front of the shredder housing 1 is provided with a movable covering board 12. The relative position between the movable covering board 12 and the opening 11 determines the width of the opening 11. When a paper jam occurs to the shredder, the user has to switch the shredder to the rev mode before removing the jammed paper. It would be inconvenient to remove the paper if the opening 11 is too narrow. Therefore, the width of the opening 11 is changed to its largest possible one so that the paper can be readily removed.

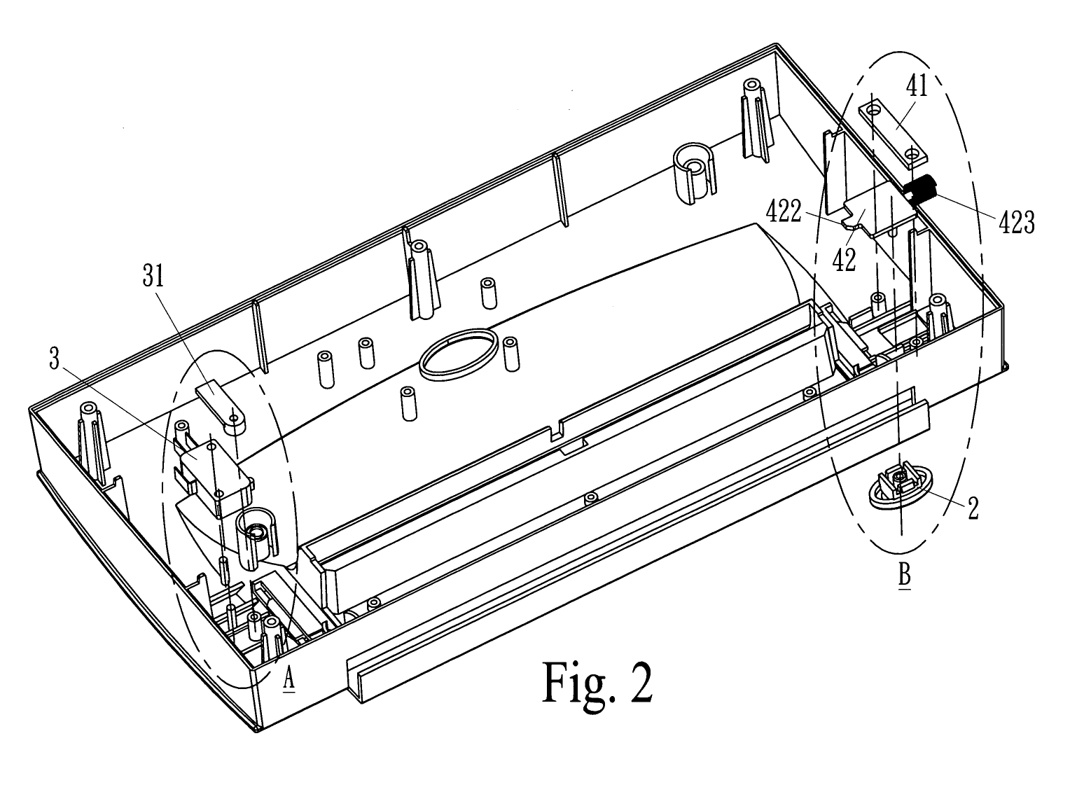

As shown in FIG. 2, the movable covering board 12 is provided with a switching button 2, which directly controls whether the movable covering board 12 is locked by a locking device inside the housing 1. That is, the switching button 2 controls the locking device to move between a lock position and a release position. The other side of the movable covering board 12 is provided with a switch 3. When the movable covering board 12 departs from the lock position of the locking device and moves toward the direction opposite to the opening 11, the switch 3 turns off the power of the shredder to stop the motor. This ensures the safety of the user while removing jammed paper.

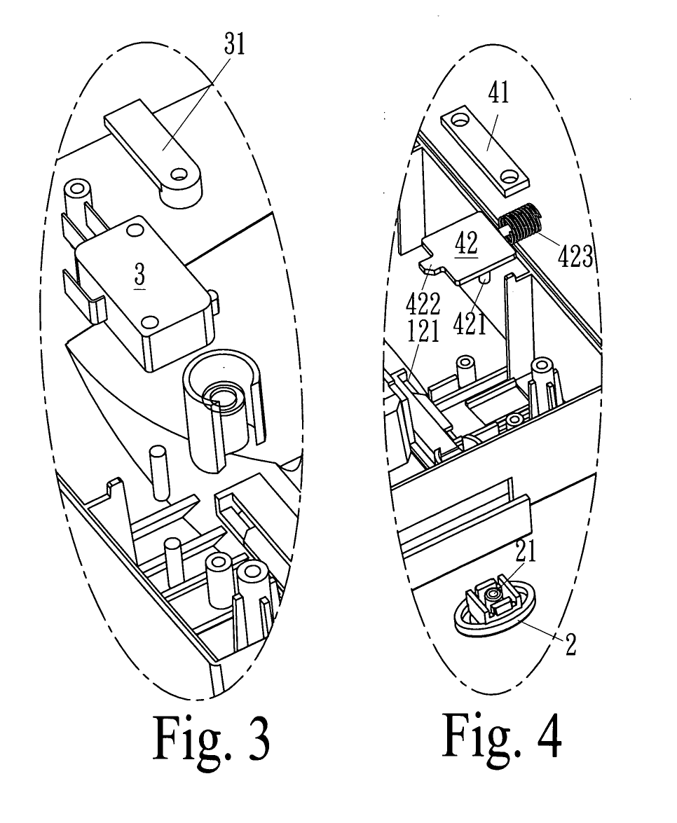

Please refer simultaneously to FIG. 3, the locally enlarged view of part A, and FIG. 4, the locally enlarged view of part B. The locking device further includes a board element 42 fixed by a pressing board 41 inside the housing 1. The front surface of the board element 42 is formed with a pin 421 to be combined with a hole 21 formed in the switching button 2 so as to move with the switching button 2. The surface of the board element 42 that faces the covering board is protruded with a lock tooth 422 for locking the covering board 12 in the lock position with the help of a cavity 121 formed on the covering board 12. A post for mounting a spring 423 is formed on the side opposite to the lock tooth 422. The switch 3 is disposed on the other side of the covering board 12, locked inside the housing 1 by a pressing board 31.

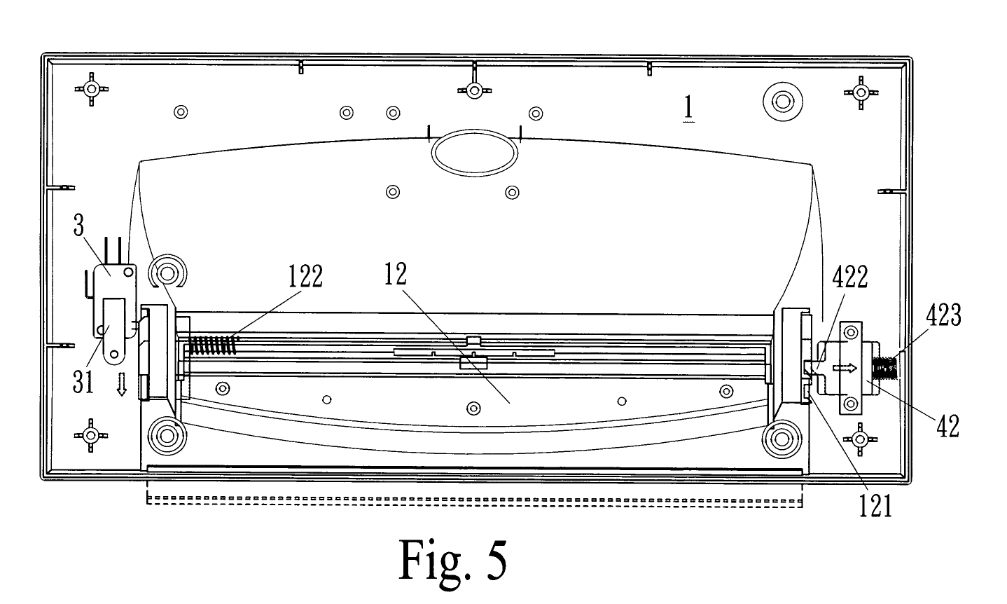

Please refer to FIG. 5 for how the disclosed covering board functions. When the switching button 2 is touched, the board element 42 is moved from the solid line position to the dashed line position (as indicated by the arrow pointing to the right), so that the lock tooth 422 departs from the cavity 121. The covering board 12 thus departs from its original lock position. The user pushes the covering board from the solid line position to the dashed line position toward the direction opposite to the opening 11 (as indicated by the arrow pointing downward), enlarging the width of the opening 11 for the convenience of removing the jammed paper. At the same time of moving the covering board 12, the switch 3 detects the motion of the covering board 12 and shuts down the power of the shredder for the safety of the user. Once the jammed paper is removed, the user's hand leaves the covering board 12. The covering board 12 is then pushed back to its original lock position by the restoring force of a twist spring 122. The spring 423 on the other end of the board element 42 also pushes the lock tooth 422 back to the cavity 121, locking the covering board 12 in the lock position.

When the disclosed shredder runs in the normal auto mode, the opening is kept at its smallest default width for preventing user's fingers from being pulled into the opening. When the paper needs to be backed out, the opening is changed to have the largest default width for the convenience of the user to take it out. Moreover, the power of the motor is shut down to ensure the safety and convenience of the user.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A shredder having a movable covering board for its opening, which comprises:
a shredder housing, whose front side has an opening;
a control element, which is provided on the shredder housing and protrudes from its surface for shifting it with a finger;
a covering board, which is provided on a surface of the shredder housing so that the width of the opening changes as the relative position between the covering board and the opening changes; and
a locking device, which is disposed inside the shredder housing and keeps the covering board in a lock position or a release position depending on the position of the control element.

2. A shredder having a movable covering board for its opening as in claim 1, wherein the control element is a switching button that controls whether the locking device locks the covering board in the lock position or the release position.

3. A shredder having a movable covering board for its opening as in claim 1, wherein the locking device includes a board element locked by a pressing board inside the shredder housing, a pin is provided on the front surface of the board element for the combination with a hole in the switching button, a lock tooth protrudes from the board element toward the covering board to lock the covering board in the lock position with the help of a cavity formed on the covering board, and a post for mounting a spring is formed on the board element in the direction opposite to the lock tooth.

4. A shredder having a movable covering board for its opening as in claim 1, wherein a switch is provided on one side of the covering board so that the switch shuts down the power of the shredder and thus its motor when the covering board departs from the lock position of the locking device and moves in the direction opposite to the opening.

5. A shredder having a movable covering board for its opening as in claim 4, wherein the switch provided on one side of the covering board is fixed inside the shredder housing by the pressing board.
